(19) United States
(12) Patent Application Publication
(10) Pub. No.: US 2026/0185906 A1
(43) Pub. Date: Jul. 2, 2026

(54) HYDRAULIC TRANSFER ASSEMBLY AND METHOD OF USING THE SAME

(71) Applicant: SAINT-GOBAIN PERFORMANCE PLASTICS CORPORATION, Malvern, PA (US)

(72) Inventor: James BOGHOSIAN, Natick, MA (US)

(21) Appl. No.: 19/427,642

(22) Filed: Dec. 19, 2025

Related U.S. Application Data
(60) Provisional application No. 63/739,222, filed on Dec. 27, 2024.

(51) Int. Cl. G01N 1/14; B01L 3/00; G01N 1/10

(52) U.S. Cl. CPC G01N 1/14; B01L 3/561; G01N 2001/1037; G01N 2001/1427

(57) ABSTRACT

The present application is directed to a sterilizable hydraulic transfer assembly including: a manual syringe including a piston, a collapsible first chamber, and a second chamber disposed at least partially around the first chamber, an input fluid line fluidly connected to the first chamber, and an output fluid line fluidly connected to the first chamber, where the first chamber is adapted to aseptically intake fluid from the input fluid line and output fluid into the output line in a closed system.

### CROSS-REFERENCE TO RELATED APPLICATION(S)

This application claims priority under 35 U.S.C. § 119(e) to U.S. Provisional Application No. 63/739,222, entitled “HYDRAULIC TRANSFER ASSEMBLY AND METHOD OF USING THE SAME,” by James David BOGHOSIAN, filed Dec. 27, 2024, which is assigned to the current assignee hereof and incorporated herein by reference in its entirety.

### FIELD OF THE DISCLOSURE

The present disclosure relates to hydraulic transfer assemblies and, more particularly, to hydraulic transfer assemblies used in sampling systems for sampling fluids from storage vessels in aseptic/sterilized environments.

### RELATED ART

Sampling systems are generally known to sample fluids from storage vessels into sampling containers (e.g. cell cultures). In some applications, sampling systems may sample cell cultures with a sampling container from a storage vessel where sterility of the storage vessel and the sampling container is desired. Conventionally, sampling may include connecting a syringe to a port of the storage vessel and manually dispensing the syringe into the sampling container, which requires careful and detailed procedures to make sure sterility is maintained to avoid contamination, adding undesired complexity and time to the sampling process. Further, conventional systems may cause undesired cell settling in the storage vessel or sampling container. Therefore, improvements in sampling systems are needed, which allow for simple and robust sampling with minimal contamination risk to the storage vessel and sampling container.

### BRIEF DESCRIPTION OF THE DRAWINGS

Embodiments are illustrated by way of example and are not limited in the accompanying figures.

FIG. 1A illustrates a schematic view of a sampling system according to a number of embodiments of the present disclosure.

FIG. 1B illustrates a side view of a sampling system according to a number of embodiments of the present disclosure.

FIG. 2A illustrates a side perspective cut away view of a syringe used in a sampling system or hydraulic transfer assembly according to a number of embodiments of the present disclosure.

FIG. 2B illustrates a side cut-away view of a syringe used in a sampling system or hydraulic transfer assembly according to a number of embodiments of the present disclosure.

FIG. 2C illustrates a side cut-away view of a syringe used in a sampling system or hydraulic transfer assembly according to a number of embodiments of the present disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the sampling system arts.

The following disclosure describes hydraulic transfer assemblies for sampling systems to achieve adequate and efficient sampling while maintaining aseptic environments (e.g., closed aseptic system). The concepts are better understood in view of the embodiments described below that illustrate and do not limit the scope of the present invention.

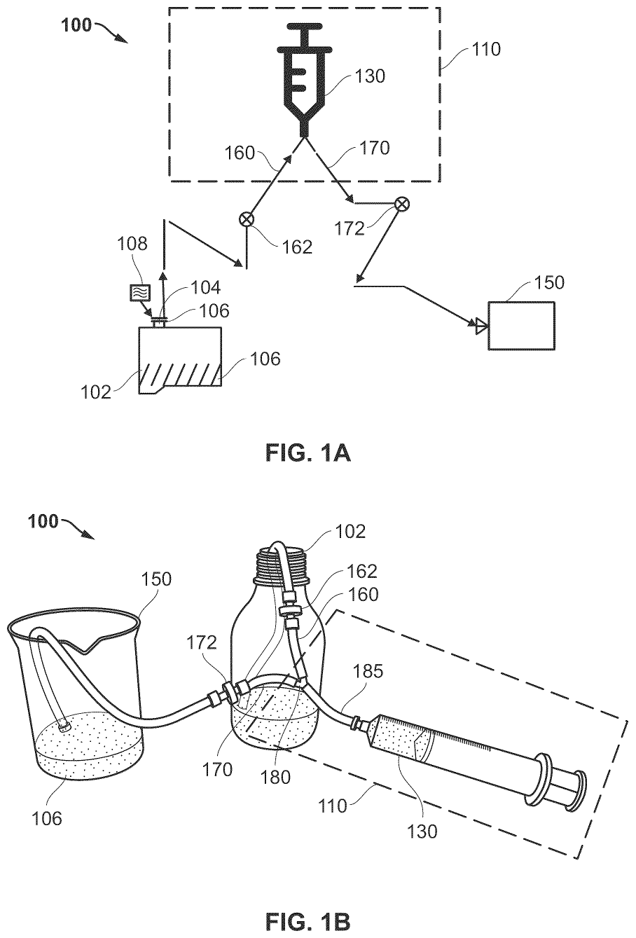

For purposes of illustration, FIG. 1A illustrates a schematic view of a sampling system 100 (also referred to herein as sampling assembly 100) according to a number of embodiments of the present disclosure. For purposes of illustration, FIG. 1B illustrates a side view of a sampling system 100 (also referred to herein as sampling assembly 100) according to a number of embodiments of the present disclosure. In a number of embodiments, any of the components of the sampling system 100 may be sterile or the entirety of the sampling system 100 may be sterile. As used herein, the term “sterile,” “aseptic,” or “sterile environment” refers to an environment that is substantially free of unintended microorganisms. In its simplest form the sampling system 100 may be manually operated, but the operation could be automated without fundamentally altering the embodiments of the invention.

As best illustrated in FIGS. 1A-1B, the sampling system 100 may include a source reservoir 102 (also referred to herein as vessel 102). In certain embodiments, the vessel 102 may be a suitable culture vessel that is configured for cell culture, such as, but not limited to, cell expansion and growth. In an embodiment, the vessel 102 may include a flexible container including a culture bag. Further, the vessel 102 may be configured to house a biological inoculum, cell culture, or growth media. As illustrated in FIGS. 1A-1B, the vessel 102 may house a fluid 108 designated to be sampled from. The vessel 102 may be a cell culture container such as, but not limited to a cell culture bag. The vessel 102 may be a bioreactor. The term “source reservoir” refers to any suitable apparatus, such as a large fermentation chamber, bioreactor, bioreactor vessel and/or culture vessel, for growing organisms such as bacteria or yeast under controlled conditions for production of substances such as pharmaceuticals, antibodies, or vaccines, or for the bioconversion of organic waste. Further, the term “sample source” includes vessels for both aerobic and anaerobic cultivation of microbial, animal, insect and plant cells, and thus encompassing a fermentor. Further, as used herein, “cell culture” entails growth, maintenance, differentiation, transfection, or propagation of cells, tissues, or their products. In some embodiments, aseptic sampling may be performed to monitor the cell culture process occurring in the vessel 102. As used herein, the term “aseptic sampling” refers to sampling while preventing entry of contamination or external impurities in the sample source or associated components. A sampling performed at a given time may be referred to as a sampling instance. In one embodiment, a plurality of sampling instances may be performed using the sampling assembly 100 in a time efficient and aseptic fashion. Additionally, as used herein, the term “sampling instance” may be used to refer to an event of drawing a sample from a sample source at a given instance in time.

In a number of embodiments, the fluid 108 may be a biological media. In a number of embodiments, the fluid 108 may include cells or a cell culture. In a number of embodiments, the fluid 108 may include a growth media. As used herein, the phrase “biological media” refers to any particle(s), substance(s), extract(s), mixture(s), and/or assembly(ies) derived from or corresponding to one or more organisms, cells, and/or viruses. As will be appreciated, cells which may be cultured in an automated cell management system includes one or more cell types including, but not limited to, animal cells, insect cells, mammalian cells, human cells, transgenic cells, genetically engineered cells, transformed cells, cell lines, plant cells, anchorage-dependent cells, anchorage-independent cells, and other cells capable of being cultured in vitro. The biological sample also includes additional components to facilitate analysis, such as fluid (for example, water), buffer, culture nutrients, salt, other reagents, dyes, and the like. Accordingly, the biological sample may include one or more cells disposed in a growth medium and/or another suitable fluid medium. In addition, as used herein, the term “biological inoculum” refers to cell culture, cells suspended in growth media, suspension cells, cell aggregates, cells attached to beads and suspended in the growth media, and the like. Further, the term “biological inoculum” also refers to various cell types, such as, but not limited to, mammalian cell types (for example, Chinese Hamster Ovary (CHO), human embryonic kidney (HEK), human embryonic stem cells (hESC), primary human cells, T-cells, and the like), insect cell types, plant cell types, microbial cell types, and the like. Moreover, as used herein, the phrase “growth medium” or “growth media” is used to refer to a liquid solution used to provide nutrients (for example, vitamins, amino acids, essential nutrients, salts, and the like) and properties (for example, similarity, buffering) to maintain living cells (or living cells in a tissue) and support their growth. Commercially available tissue growth medium is known to those skilled in the art. The phrase “cell growth medium” as used herein means tissue growth medium that has been incubated with cultured cells in forming a cell culture; and more preferably refers to tissue growth medium that further includes substances secreted, excreted or released by cultured cells, or other compositional and/or physical changes that occur in the medium resulting from culturing the cells in the presence of the tissue growth medium.

In a number of embodiments, as shown best in FIG. 1A, the vessel 102 may include a port 104 adapted to allow fluid 108 to exit the vessel 102. In a number of embodiments, the port 104 may include a cap 106. The cap 106 may include a bore allowing fluid 108 to escape the vessel 102 via the port 104. In an embodiment, a sterile air filter 106 may be associated with the port 104 or vessel 102. In an embodiment, a sterile air filter 106 may be located on the cap 106. The presence of a sterile air filter 106 ensures that any air entering the sampling system 100 is sterile. In a number of embodiments, the cap 106 may be a two-bore cap with one bore being the port 104 and the second bore being the sterile air filter 106.

As illustrated in FIGS. 1A-1B, in a number of embodiments, the sampling system 100 may include a hydraulic transfer assembly (indicated by dotted line 110). In a number of embodiments, the hydraulic transfer assembly 100 may include any of the materials listed below. In a number of embodiments, the hydraulic transfer assembly 100 may be sterilized and/or autoclavable. In an embodiment, the sampling system 100 and/or hydraulic transfer assembly 100 may include a syringe 130 operably and/or fluidly connected to a vessel 102. As used herein, the term “fluidly connected” refers to a relationship between two components by which fluid can be permitted to flow from one component to the other. The size of the syringe 130 may be selected according to the particular application or sampling operation carried out, and may range from about 0-5 mL, or from about 1-3 mL, although smaller or larger collection volumes are also envisioned by utilizing an appropriately sized syringe 130. In an embodiment, an additional sterile air filter may be located on the syringe 130.

As illustrated in FIGS. 1A-1B, in a number of embodiments, the vessel 102 may be operably and/or fluidly connected to the syringe 130 via an input line 160. The input line 160 may include tubing. As used herein, the term “tubing” may refer to at least a portion of one or more of a sampling conduit, a recovery conduit, and one or more sub-conduits. The tubing may be sterile-weldable and is generalized to include any length and include any sterile connections thereof. Further, the tubing may be generalized to include any fittings between neighboring tubing portions. In a number of embodiments, the tubing may be a chemically inert material allowing movement of fluid 108 therein and may include any of the materials listed below. Conventional tubing materials, such as weldable PVC and other polymers are contemplated as part of the tubing referred to herein. In a number of embodiments, the input line 160 may include at least one valve 162. The at least one valve 162 may include a gate valve, a check valve, or a butterfly valve. In an embodiment, the at least one valve 162 may be positioned to prevent fluid 108 from being inadvertently pushed back into the vessel 102. As illustrated best in FIG. 1A, the input line 160 may be fitted with at least one valve 162 which permits only unidirectional flow of fluid 108 as indicated by the arrows. In an embodiment, the various components of the sampling system 100 may be fluidly interconnected at sterile weld points along the input line 160 tubing. In an embodiment, an additional sterile air filter may be located along the input line 160 or at the at least one valve 162. It is contemplated that the at least one valve 162 can be manually controlled or controlled automatically via an actuator.

As illustrated in FIGS. 1A-1B, in a number of embodiments, the sampling system 100 may include a sampling reservoir 150 operably and/or fluidly connected to at least one of the vessel 102 or the manual syringe 130. As illustrated in FIG. 1, the sampling reservoir 150 may house a fluid 108 from the designated vessel 102 through operation of the sampling system 100 and/or hydraulic transfer assembly 110. In an embodiment, the sampling reservoir 150 may be a vacutainer collection tube, a receptacle, or may be another type. In certain embodiments, the sampling reservoir 150 may be a suitable culture vessel that is configured for cell culture, such as, but not limited to, cell expansion and growth. In an embodiment, the sampling reservoir 150 may include a flexible container including a culture bag. Further, the sampling reservoir 150 may be configured to house a biological inoculum, cell culture, or growth media. As illustrated in FIG. 1, the sampling reservoir 150 may house a fluid 108 designated to be sampled from. The sampling reservoir 150 may be a cell culture container such as, but not limited to, a cell culture bag. The sampling reservoir 150 may be a bioreactor.

As illustrated in FIGS. 1A-1B, in a number of embodiments, the sampling reservoir 150 operably and/or fluidly connected to the syringe 130 via an output line 160. The output line 170 may include tubing. In a number of embodiments, the tubing may be a chemically inert material allowing movement of fluid 108 therein. Conventional tubing materials, such as weldable PVC and other polymers are contemplated as part of the tubing referred to herein. In a number of embodiments, the output line 170 may include at least one valve 172. The at least one valve 172 may include a gate valve, a check valve, or a butterfly valve. In an embodiment, the at least one valve 172 may be positioned to prevent fluid 108 from being inadvertently pushed back into the syringe 130. As illustrated best in FIG. 1A, the output line 170 may be fitted with at least one valve 172 which permits only unidirectional flow of fluid 108 as indicated by the arrows. In an embodiment, the various components of the sampling system 100 may be fluidly interconnected at sterile weld points along the output line 170 tubing. In an embodiment, an additional sterile air filter may be located along the output line 170 or at the at least one valve 172. It is contemplated that the at least one valve 172 can be manually controlled or controlled automatically via an actuator.

In an embodiment, shown best in FIG. 1B, the input line 160 and the output line 170 may meet at a tubing intersection 180 within the hydraulic transfer assembly 110. The tubing intersection 180 may operatively or fluidly connect the input line 160 and the output line 170 to the syringe 130. In an embodiment, the tubing intersection 180 may be a 3-way line or wye connection. In an embodiment, the tubing intersection 180 may include an additional tubing 185 operatively or fluidly connecting directly to the syringe 130.

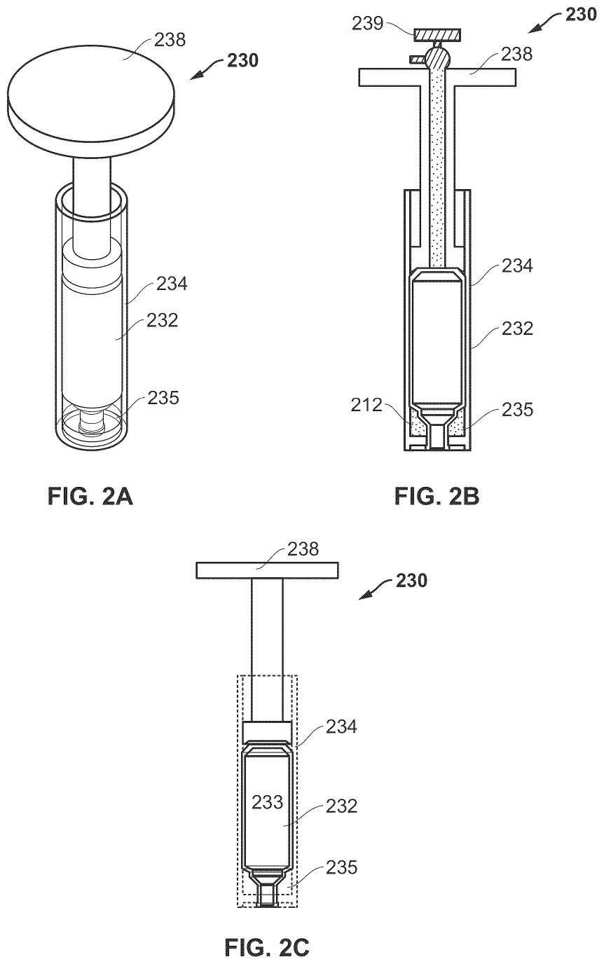

As stated above, the sampling system 100 and/or hydraulic transfer assembly 100 may include a syringe 130 operably and/or fluidly connected to a vessel 102 and the sampling reservoir 150. For purposes of illustration, FIG. 2A illustrates a side perspective cut away view of a syringe used in a sampling system or hydraulic transfer assembly according to a number of embodiments of the present disclosure. For purposes of illustration, FIG. 2B illustrates a side cut-away view of a syringe used in a sampling system or hydraulic transfer assembly according to a number of embodiments of the present disclosure. For purposes of illustration, FIG. 2C illustrates a side cut-away view of a syringe used in a sampling system or hydraulic transfer assembly according to a number of embodiments of the present disclosure. As shown in FIGS. 2A-2C, the syringe 230 may include a first chamber 232 including an interior cavity 233. The first chamber 232 may be adapted to be collapsed upon application of pressure. In a number of embodiments, the first chamber 232 may include an elastic material as described below. In a number of embodiments, the first chamber 232 may include a flexible membrane as described below.

As shown in FIGS. 2A-2C, the syringe 230 may include a second chamber 234. The second chamber 234 may be adapted to at least partially surround the first chamber 232. In a number of embodiments, the second chamber 234 may include a rigid material as described below. In a number of embodiments, the second chamber 234 may include a polymer as described below. In a number of embodiments, at least one void 235 may exist radially between the first chamber 232 and the second chamber 234. In a number of embodiments, the at least one void 235 may contain an incompressible fluid.

As shown in FIGS. 2A-2C, the syringe 230 may include a piston 238. The piston 238 may be adapted to be above the first chamber 232 such that the first chamber 232 may be disposed entirely below the piston 238. In a number of embodiments, the piston 238 may include a rigid material as described below. In a number of embodiments, the piston 238 may include a polymer as described below. In a number of embodiments, the piston 238 may be adapted to collapse an incompressible fluid 212 located within the void 235 between the first chamber 232 and the second chamber 234 to collapse the first chamber 232 in turn. In a number of embodiments, as shown best in FIG. 2B, the piston 238 may include a stopcock 239 adapted to vent the incompressible fluid 212 to the surrounding atmosphere through a void or hollow section in the piston 238. In a number of embodiments, the piston 238 may include a rigid material as described below. In a number of embodiments, the piston 238 may include a polymer as described below.

In a number of embodiments, referring back to FIGS. 1A-1B, a method of moving fluid 108 may be accomplished by the sampling system 100 and/or hydraulic transfer assembly 110. The fluid 108 may move from the source reservoir 102 via actuation of the syringe 130. In a number of embodiments, the syringe 130 may aseptically intake or input fluid from the source reservoir or vessel 102 into the collapsible first chamber via the input fluid line 160 through actuation (manual or automatic) of the piston of the syringe 130. In other words, the piston may be at least partially withdrawn from the second chamber, allowing fluid 108 to enter the collapsible first chamber as the incompressible fluid in the void between the first chamber and the second chamber expands into the newly vacated void space in the second chamber. In a number of embodiments, the syringe 130 may output fluid 108 from the collapsible first chamber into the sampling reservoir 150 via the output line 170 through actuation (manual or automatic) of the piston of the syringe 130. In other words, the piston may be at least partially re-inserted into the second chamber, compressing the void and incompressible fluid therein, thereby compressing the collapsible first chamber to force fluid 108 into the output fluid line 170 and ultimately the sampling reservoir 150. In this way, actuating the syringe 130 aseptically transitions fluid 108 from the source reservoir 102 to the sampling reservoir 150 in a closed system. A “closed system” may be defined herein as a system preventing environmental exposure of the fluid transitioned within the system. As described, the amount of fluid 108 moved between components may be verified by automated optical sensing methods, mechanical stops, by markings on the syringe, and/or by weight. Further, purging of the hydraulic transfer assembly 110 is contemplated herein.

In particular embodiments, at least one of the components of the sampling system (including at least one of the components of the syringe, input line, output line, sampling container, or vessel) can be formed of a material including, metal, plastic, glass, or combinations thereof, and particularly Pyrex. In certain embodiments, at least one of the components of the sampling system can be formed of a material including plastic or glass. In an embodiment, at least one of the components of the sampling system may include a polymer. In an embodiment, at least one of the components of the sampling system may include a blend of polymers or polymeric polymers including a thermoplastic elastomeric hydrocarbon block copolymer, a polyether-ester block co-polymer, a thermoplastic polyamide elastomer, a thermoplastic polyurethane elastomer, a thermoplastic polyolefin elastomer, a thermoplastic vulcanizate, an olefin-based co-polymer, an olefin-based ter-polymer, a polyolefin plastomer, or combinations thereof. In an embodiment, at least one of the components of the sampling system may include a styrene-based block copolymer such as styrene-butadiene, styrene-isoprene, blends or mixtures thereof, and the like. Exemplary styrenic thermoplastic elastomers include triblock styrenic block copolymers (SBC) such as styrene-butadiene-styrene (SBS), styrene-isoprene-styrene (SIS), styrene-ethylene butylene-styrene (SEBS), styrene-ethylene propylene-styrene (SEPS), styrene-ethylene-ethylene-butadiene-styrene (SEEBS), styrene-ethylene-ethylene-propylene-styrene (SEEPS), styrene-isoprene-butadiene-styrene (SIBS), or combinations thereof. Commercial examples include some grades of Kraton™ and Hybrar™ resins.

In an embodiment, at least one of the components of the sampling system may include a polyolefin polymer. A typical polyolefin may include a homopolymer, a copolymer, a terpolymer, an alloy, or any combination thereof formed from a monomer, such as ethylene, propylene, butene, pentene, methyl pentene, hexene, octene, or any combination thereof. In an embodiment, the polyolefin polymer may be copolymers of ethylene with propylene or alpha-olefins or copolymers of polypropylene with ethylene or alpha-olefins made by metallocene or non-metallocene polymerization processes. Commercial polyolefin examples include Affinity™, Engage™, Flexomer™, Versify™, Infuse™, Exact™, Vistamaxx™, Softel™ and Tafmer™, Notio™ produced by Dow, ExxonMobil, Londel-Basell and Mitsui. In an embodiment, the polyolefin polymer may include copolymers of ethylene with polar vinyl monomers such as acetate (EVA), acrylic acid (EAA), methyl acrylate (EMA), methyl methacrylate (EMMA), ethyl acrylate (EEA) and butyl acrylate (EBA). Exemplary suppliers of these ethylene copolymer resins include DuPont, Dow Chemical, Mitusi and Arkema etc. In another embodiment, the polyolefin polymer can be a terpolymer of ethylene, maleic anhydride and acrylates such as Lotader™ made by Arkema and Evalloy™ produced by DuPont. In yet another embodiment, the polyolefin polymer can be an ionomer of ethylene and acrylic acid or methacrylic acid such as Surlyn™ made by DuPont. In an embodiment, the polyolefin is a reactor grade thermoplastic polyolefin polymer, such as P6E2A-005B available from Flint Hills Resources. In very particular embodiments, the thermoplastic tube can include a C-FLEX® brand biopharmaceutical tubing (available from Saint-Gobain Performance Plastics Corporation at Clearwater, Florida, USA). In an embodiment, at least one of the components of the sampling system may include, but are not limited to, thermoplastic, thermosets, fluoropolymers, and combinations thereof. Specific examples of suitable polymer material can be polyvinylidene fluoride (PVDF). In an embodiment, at least one of the components of the sampling system can be formed of a thermoplastic elastomer, silicone, or combinations thereof.

In an embodiment, at least one of the components of the sampling system may include a fluorinated polymer. In an embodiment, at least one of the components of the sampling system may include a polymer including at least one of polytetrafluoroethylene (PTFE), modified polytetrafluoroethylene (mPTFE), ethylene-tetrafluoroethylene (ETFE), perfluoroalkoxyethylene (PFA), tetrafluoroethylene-hexafluoropropylene (FEP), tetrafluoro-ethylene-perfluoro (methyl vinyl ether) (MFA), polyvinylidene fluoride (PVDF), ethylene-chlorotrifluoroethylene (ECTFE), polyimide (PI), polyamidimide (PAI), polyphenylene sulfide (PPS), polyethersulofone (PES), polyphenylene sulfone (PPSO2), liquid crystal polymers (LCP), polyetherketone (PEK), polyether ether ketones (PEEK), aromatic polyesters (Ekonol), of polyether-ether-ketone (PEEK), polyetherketone (PEK), liquid crystal polymer (LCP), polyamide (PA), polyoxymethylene (POM), polyethylene (PE)/UHMPE, polypropylene (PP), polystyrene, styrene butadiene copolymers, polyesters, polycarbonate, polyacrylonitriles, polyamides, styrenic block copolymers, ethylene vinyl alcohol copolymers, ethylene vinyl acetate copolymers, polyesters grafted with maleic anhydride, poly-vinylidene chloride, aliphatic polyketone, liquid crystalline polymers, ethylene methyl acrylate copolymer, ethylene-norbomene copolymers, polymethylpentene and ethylene acyrilic acid copoloymer, mixtures, copolymers and any combination thereof. In a specific embodiment, at least one of the components of the sampling system may include a perfluoroalkoxyalkane (PFA).

In an embodiment, at least one of the components of the sampling system may include Acrylonitrile-Butadiene (NBR), Carboxylated Nitrile (XNBR), Ethylene Acrylate (AEM, Vamac®), Ethylene Propylene Rubber (EPR, EPDM), Butyl Rubber (IIR), Chloroprene Rubber (CR), Fluorocarbon (FKM, FPM), Fluorosilicone (FVMQ), Hydrogenated Nitrile (HNBR), Perfluoroelastomer (FFKM), Polyacrylate (ACM), Polyurethane (AU, EU), Silicone Rubber (Q, MQ, VMQ, PVMQ), Tetrafluoroethylene-Propylene (AFLAS®) (FEPM).

In an embodiment, at least one of the components of the sampling system may include a metal or metal alloy. In an embodiment, the metal may be aluminum, iron, tin, platinum, titanium, magnesium, alloys thereof, or maybe a different metal. Further, the metal can include steel. The steel can include stainless steel, such as austenitic stainless steel. Moreover, the steel can include stainless steel including chrome, nickel, or a combination thereof. For example, the steel can include X10CrNi18-8 stainless steel.

Further, in an embodiment, at least one of the components of the sampling system can include one or more additives. For example, the one or more additives can include a plasticizer, a catalyst, a silicone modifier, a silicon component, a stabilizer, a curing agent, a lubricant, a colorant, a filler, a blowing agent, another polymer as a minor component, or a combination thereof.

In an embodiment, at least one of the components of the sampling system can be formed as a single piece or may be formed as multiple pieces. In an embodiment, at least one of the components of the sampling system can be a molded component. In an embodiment, at least one of the components of the sampling system can be formed through over-molding or other methods known in the art. In an embodiment, the polymer or polymeric blend included in at least one of the components of the sampling system may be processed by any known method to form the polymeric mixture. The polymer or polymeric blend may be melt processed by dry blending or compounding. The dry blend may be in powder, granular, or pellet form. The blend can be made by a continuous twin-screw compounding process or batch-related Banbury process. Pellets of these mixtures may then be fed into a single screw extruder to make articles such as flexible tubing products. Mixtures can also be mixed in a single-screw extruder equipped with mixing elements and then extruded directly into articles such as tubing products. In a particular embodiment, the mixture can be melt processed by any method envisioned known in the art such as laminating, casting, molding, extruding, and the like. In an embodiment, the mixture can be injection molded.

In an embodiment, the polymer or polymeric blend can advantageously withstand sterilization processes. In an embodiment, the polymer or polymeric blend may be sterilized by any method envisioned. For instance, the polymer or polymeric blend is sterilized after at least one of the components of the sampling system is formed. Exemplary sterilization methods include steam, gamma, ethylene oxide, E-beam techniques, combinations thereof, and the like. Further, the polymer or polymeric blend may be able to undergo autoclave sterilization. In a particular embodiment, the polymer or polymeric blend is sterilized by gamma irradiation. For instance, the polymer or polymeric blend of at least one of the components of the sampling system may be gamma sterilized at between about 25 kGy to about 55 kGy. In a particular embodiment, the polymer or polymeric blend is sterilized by steam sterilization. In an exemplary embodiment, the polymer or polymeric blend is heat-resistant to steam sterilization at temperatures up to about 130° C. for a time of up to about 45 minutes. In an embodiment, the polymer or polymeric blend is heat resistant to steam sterilization at temperatures of up to about 135° C. for a time of up to about 30 minutes.

In an embodiment, the polymer or polymeric blend of at least one of the components of the sampling system may be formed into a single layer article, a multi-layer article, or can be laminated, coated, or formed on a substrate to form at least one of the components of the sampling system. Multi-layer articles may include layers such as reinforcing layers, adhesive layers, barrier layers, chemically resistant layers, metal layers, any combination thereof, and the like. The polymer or polymeric blend can be formed into any useful shape such as film, sheet, tubing, and the like to form at least one of the components of the sampling system.

In embodiment, at least one of the components of the sampling system may have further desirable physical and mechanical properties. For instance, at least one of the components of the sampling system may appear transparent or at least translucent. In a specific example, the container housing of the sterile sampling container assembly is transparent or translucent. For instance, at least one of the components of the sampling system may have a light transmission greater than about 2%, or greater than about 5% in the visible light wavelength range. In particular, the resulting articles have desirable clarity or translucency. In addition, at least one of the components of the sampling system have advantageous physical properties, such as a balance of any one or more of the properties of hardness, flexibility, surface lubricity, valve life, spallation, fouling, tensile strength, elongation, Shore A hardness, gamma resistance, weld strength, and seal integrity to an optimum level.

In an embodiment, at least one of the components of the sampling system may have desirable heat stability properties. In a particular embodiment, at least one of the components of the sampling system has one more of the following heat resistance properties such as a higher burst resistance, a higher softening point, and/or a higher autoclaving temperature compared to currently available commercial products. Applications for the polymer or polymeric blend are numerous. In particular, the polymer or polymeric blend is non-toxic, making the material useful for any application where no toxicity is desired. For example, the polymer or polymeric blend may be substantially free of plasticizers or other low-molecular weight extenders that can be leached into the fluids it transfers. “Substantially free” as used herein refers to a polymeric mixture having a total organics content (TOC) (measured in accordance to ISO 15705 and EPA 410.4) of less than about 100 ppm. Further, the polymer or polymeric blend has biocompatibility and animal derived component-free formulation ingredients. For instance, the polymeric mixture has potential for FDA, USP, EP, ISO, and other regulatory approvals. In an exemplary embodiment, the polymer or polymeric blend may be used in applications such as industrial, medical, health care, biopharmaceutical, pharmaceutical, drinking water, food & beverage, laboratory, dairy, and the like. In an embodiment, the polymeric mixture may be used in applications where low-temperature resistance is desired. In an embodiment, the polymer or polymeric blend may also be safely disposed as it generates substantially no toxic gases when incinerated and leaches no plasticizers into the environment if land filled.

In a number of embodiments, a method is shown. The method may include providing a source reservoir including a fluid. The method may include providing a sampling reservoir for receiving the fluid. The method may include providing a sterilizable hydraulic transfer assembly including: a manual syringe including a piston, a collapsible first chamber, and a second chamber disposed at least partially around the first chamber, an input fluid line fluidly connecting the source reservoir and the first chamber, and an output fluid line fluidly connecting the first chamber and the sampling reservoir. The method may include actuating the syringe to aseptically transition fluid from the source reservoir into the first chamber through the input fluid line. The method may include actuating the syringe to aseptically transition fluid from the first chamber to the sampling reservoir through the output line resulting in transfer of the fluid from the source reservoir to the sampling reservoir in a closed system.

Use of the sampling system may provide increased benefits in several applications in fields such as, but not limited to, industrial, medical, health care, biopharmaceutical, pharmaceutical, drinking water, food & beverage, laboratory, dairy, or other types of applications. Notably, the use of the sampling system may provide a means for accurately sampling from a fluid vessel easily at multiple sample sizes while maintaining sterility, decreasing complexity, minimizing waste, and minimizing labor and time necessary to sample fluids from vessel in clean room settings. Further, the sampling system may decrease cell settling in the sampling system, providing more accurate sampling. Lastly, the sampling system may be reusable and provides a fully closed manual culture system that obviates sterility and contamination issues that have not been solved using existing systems and methods.

Many different aspects and embodiments are possible. Some of those aspects and embodiments are described below. After reading this specification, skilled artisans will appreciate that those aspects and embodiments are only illustrative and do not limit the scope of the present invention.

Embodiment 1: A sterilizable hydraulic transfer assembly comprising: a manual syringe comprising a piston, a collapsible first chamber, and a second chamber disposed at least partially around the first chamber, an input fluid line fluidly connected to the first chamber, and an output fluid line fluidly connected to the first chamber, wherein the first chamber is adapted to aseptically intake fluid from the input fluid line and output fluid into the output line in a closed system.

Embodiment 2: A sampling system comprising: a source reservoir comprising a fluid; a sampling reservoir for receiving the fluid; and a sterilizable hydraulic transfer assembly comprising: a manual syringe comprising a piston, a collapsible first chamber, and a second chamber disposed at least partially around the first chamber, an input fluid line fluidly connecting the source reservoir and the first chamber, an output fluid line fluidly connecting the first chamber and the sampling reservoir, wherein the first chamber is adapted to aseptically intake fluid from the input fluid line and output fluid into the output line, resulting in transfer of the fluid from the source reservoir to the sampling reservoir in a closed system.

Embodiment 3: A method of sampling fluid comprising: providing a source reservoir comprising a fluid; providing a sampling reservoir for receiving the fluid; providing a sterilizable hydraulic transfer assembly comprising: a manual syringe comprising a piston, a collapsible first chamber, and a second chamber disposed at least partially around the first chamber, an input fluid line fluidly connecting the source reservoir and the first chamber, an output fluid line fluidly connecting the first chamber and the sampling reservoir; actuating the syringe to aseptically transition fluid from the source reservoir into the first chamber through the input fluid line; and actuating the syringe to aseptically transition fluid from the first chamber to the sampling reservoir through the output line resulting in transfer of the fluid from the source reservoir to the sampling reservoir in a closed system.

Embodiment 4: The sterilizable hydraulic transfer assembly, sampling system, or method of any of the preceding embodiments, wherein the first chamber comprises an elastic material.

Embodiment 5: The sterilizable hydraulic transfer assembly, sampling system, or method of any of the preceding embodiments, wherein the first chamber comprises a flexible membrane comprising an elastomer or rubber.

Embodiment 6: The sterilizable hydraulic transfer assembly, sampling system, or method of any of the preceding embodiments, wherein the second chamber comprises a rigid material.

Embodiment 7: The sterilizable hydraulic transfer assembly, sampling system, or method of any of the preceding embodiments, wherein the second chamber comprises a polymer.

Embodiment 8: The sterilizable hydraulic transfer assembly, sampling system, or method of any of the preceding embodiments, wherein the first chamber is disposed entirely below the piston.

Embodiment 9: The sterilizable hydraulic transfer assembly, sampling system, or method of any of the preceding embodiments, wherein the second chamber at least partially surrounds the piston.

Embodiment 10: The sterilizable hydraulic transfer assembly, sampling system, or method of any of the preceding embodiments, wherein the input fluid line comprises tubing comprising a polymer or a silicone.

Embodiment 11: The sterilizable hydraulic transfer assembly, sampling system, or method of any of the preceding embodiments, wherein the output fluid line comprises tubing comprising a polymer or a silicone.

Embodiment 12: The sterilizable hydraulic transfer assembly, sampling system, or method of any of the preceding embodiments, further comprising at least one valve operatively separating the input fluid line and the output fluid line.

Embodiment 13: The sterilizable hydraulic transfer assembly, sampling system, or method of embodiment 12, wherein the at least one valve comprises a gate valve, a check valve, or a butterfly valve.

Embodiment 14: The sterilizable hydraulic transfer assembly, sampling system, or method of any of the preceding embodiments, wherein the fluid comprises a biological agent.

Embodiment 15: The sterilizable hydraulic transfer assembly, sampling system, or method of embodiment 14, wherein the biological agent comprises a cell culture media.

Embodiment 16: The sterilizable hydraulic transfer assembly, sampling system, or method of any of the preceding embodiments, wherein the sampling reservoir comprises a flexible container comprising a culture bag.

Embodiment 17: The sterilizable hydraulic transfer assembly, sampling system, or method of any of the preceding embodiments, wherein the source reservoir comprises a flexible container comprising a culture bag.

Embodiment 18: The sterilizable hydraulic transfer assembly, sampling system, or method of any of the preceding embodiments, wherein the source reservoir further comprises a cap.

Embodiment 19: The sterilizable hydraulic transfer assembly, sampling system, or method of any of the preceding embodiments, further comprising a filter located within at least one of the input fluid line, the output fluid line, or the syringe.

Embodiment 20: The sterilizable hydraulic transfer assembly, sampling system, or method of embodiment 18, further comprising a filter located on the cap of the source reservoir.

Embodiment 21: The sterilizable hydraulic transfer assembly, sampling system, or method of any of the preceding embodiments, wherein the sterilizable hydraulic transfer assembly is autoclavable.

Embodiment 22: The sterilizable hydraulic transfer assembly, sampling system, or method of any of the preceding embodiments, wherein at least one void exists radially between the first chamber and the second chamber.

Embodiment 23: The sterilizable hydraulic transfer assembly, sampling system, or method of any of the preceding embodiments, wherein the piston collapses an incompressible fluid which in turn compresses the collapsible chamber.

Embodiment 24: The sterilizable hydraulic transfer assembly, sampling system, or method of embodiment 23, wherein the piston comprises a stopcock that is adapted to vent the incompressible fluid to the surrounding atmosphere.

Embodiment 25: The method of any of embodiments 4-24, further comprising, removing the sampling container from the sample container housing of the sampling container assembly.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

Note that not all of the activities described above in the general description or the examples are required, that a portion of a specific activity may not be required, and that one or more further activities may be performed in addition to those described. Still further, the order in which activities are listed are not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed:

1. A sterilizable hydraulic transfer assembly comprising:
a manual syringe comprising a piston, a collapsible first chamber, and a second chamber disposed at least partially around the first chamber,
an input fluid line fluidly connected to the first chamber, and
an output fluid line fluidly connected to the first chamber, wherein the first chamber is adapted to aseptically intake fluid from the input fluid line and output fluid into the output line in a closed system.

2. A sampling system comprising:
a source reservoir comprising a fluid;
a sampling reservoir for receiving the fluid; and
a sterilizable hydraulic transfer assembly comprising:
a manual syringe comprising a piston, a collapsible first chamber, and a second chamber disposed at least partially around the first chamber,
an input fluid line fluidly connecting the source reservoir and the first chamber,
an output fluid line fluidly connecting the first chamber and the sampling reservoir, wherein the first chamber is adapted to aseptically intake fluid from the input fluid line and output fluid into the output line, resulting in transfer of the fluid from the source reservoir to the sampling reservoir in a closed system.

3. A method of sampling fluid comprising:
providing a source reservoir comprising a fluid;
providing a sampling reservoir for receiving the fluid;
providing a sterilizable hydraulic transfer assembly comprising:
a manual syringe comprising a piston, a collapsible first chamber, and a second chamber disposed at least partially around the first chamber,
an input fluid line fluidly connecting the source reservoir and the first chamber,
an output fluid line fluidly connecting the first chamber and the sampling reservoir;
actuating the syringe to aseptically transition fluid from the source reservoir into the first chamber through the input fluid line; and
actuating the syringe to aseptically transition fluid from the first chamber to the sampling reservoir through the output line resulting in transfer of the fluid from the source reservoir to the sampling reservoir in a closed system.

4. The sterilizable hydraulic transfer assembly of claim 1, wherein the first chamber comprises an elastic material.

5. The sterilizable hydraulic transfer assembly of claim 1, wherein the first chamber comprises a flexible membrane comprising an elastomer or rubber.

6. The sterilizable hydraulic transfer assembly of claim 1, wherein the second chamber comprises a rigid material.

7. The sterilizable hydraulic transfer assembly of claim 1, wherein the second chamber comprises a polymer.

8. The sterilizable hydraulic transfer assembly of claim 1, wherein the first chamber is disposed entirely below the piston.

9. The sterilizable hydraulic transfer assembly of claim 1, wherein the second chamber at least partially surrounds the piston.

10. The sterilizable hydraulic transfer assembly of claim 1, wherein the input fluid line comprises tubing comprising a polymer or a silicone.

11. The sterilizable hydraulic transfer assembly of claim 1, wherein the output fluid line comprises tubing comprising a polymer or a silicone.

12. The sterilizable hydraulic transfer assembly of claim 1, further comprising at least one valve operatively separating the input fluid line and the output fluid line.

13. The sterilizable hydraulic transfer assembly of claim 1, wherein the sampling reservoir comprises a flexible container comprising a culture bag.

14. The sterilizable hydraulic transfer assembly of claim 1, wherein the source reservoir comprises a flexible container comprising a culture bag.

15. The sterilizable hydraulic transfer assembly of claim 1, wherein the source reservoir further comprises a cap.

16. The sterilizable hydraulic transfer assembly of claim 1, further comprising a filter located within at least one of the input fluid line, the output fluid line, or the syringe.

17. The sterilizable hydraulic transfer assembly of claim 1, wherein at least one void exists radially between the first chamber and the second chamber.

18. The sterilizable hydraulic transfer assembly of claim 1, wherein the piston collapses an incompressible fluid which in turn compresses the collapsible chamber.

19. The sterilizable hydraulic transfer assembly of claim 18, wherein the piston comprises a stopcock that is adapted to vent the incompressible fluid to the surrounding atmosphere.

20. The method of claim 3, further comprising, removing the sampling container from the sample container housing of the sampling container assembly.
